(19) United States
(12) Patent Application Publication
(10) Pub. No.: US 2007/0165879 A1
(43) Pub. Date: Jul. 19, 2007

(54) Dual Microphone System and Method for Enhancing Voice Quality

(75) Inventors: Hao Deng, Beijing (CN); Yuhong Feng, Beijing (CN); Zhongsong Lin, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/623,072

(22) Filed: Jan. 13, 2007

(30) Foreign Application Priority Data
Jan. 13, 2006 (CN) 200610001158.6

(51) Int. Cl. H04R 3/00; H04R 1/02

(52) U.S. Cl. 381/92; 381/91; 381/110

(57) ABSTRACT

Techniques to enhance voice signals in a dual microphone system are disclosed. According to one aspect of the present invention, there are at least two microphones that are positioned in a pre-configured array. Two audio signals x₁(k) and x₂(k) are received and coupled to an adjusting module that is provided to control the gain of each of the audio signals x₁(k) and x₂(k) to minimize signal differences between the two signals. A separation module is provided to receive matched audio signals x′₁(k) and x′₂(k) from the adjusting module. The separation module separates the audio signals x′₁(k) and x′₂(k) to obtain a first audio signal s(k) containing mainly the voice and a second audio signal n(k) containing mainly the noise. An adaptive filtering module is provided to eliminate the noise component in the audio signal s(k) to obtain an estimated voice signal e_s(k) with a higher S/N ratio. Furthermore, the adaptive filtering module can be also configured to suppress echo in the audio signal s(k) at same time. The voice signal e_s(k) may be further coupled to a single-channel voice enhancement module that is configured to eliminate any residual of the noise component in the voice signal e_s(k) according to the differences between the voice signal and the noise signal in time domain and frequency domain, whereby, the S/N ratio is further enhanced.

### BACKGROUND OF THE INVENTION

1. Field of the Invention

The present invention relates to the area of audio or voice enhancement, and more particularly to voice enhancement techniques applied in portable devices, such as mobile communication devices.

2. Description of Related Art

Mobile communication provides the convenience of being connected at anytime and anywhere. However, ambient noise may significantly affect voice quality in communication. When making a phone call in a noisy location, such as in a railway station, airport, restaurant or ballroom, the surrounding noise can be together with the voice signal sent to another end. In order to make a listener hear clearly, the speaker has to speak loudly, which often induce the listener to respond loudly. As a result, both the speaker and the listener would look anxious and feel exhausted.

To reduce the impact of the surrounding noise to the voice, various techniques for voice enhancement have been designed, and may be implemented via a single microphone or dual microphones. For example, the single-channel voice enhancement technique suppresses a noise signal by utilizing differences between the voice signal and the noise signal in time domain and frequency domain. The single-channel voice enhancement technique has an advantage of simple implementation. However, there are a few problems. The first one is that the voice audibility and fidelity may be damaged during the process of noise suppression, especially when the input S/N ratio is relatively low. The second one is that if the noise signal, such as background human voice or background music, may have similar characteristics to the voice signal, the noise suppression process may be less effective. The third one is that when the S/N ratio is rather low such as lower than 0 dB, the noise suppression process may be ineffective at all.

Generally, a dual microphone voice enhancement technique may be used. One microphone is positioned far away from a noise source but near to the voice source to record the signal mainly containing the voice, the other microphone is positioned far from the voice source but near the noise source to record signal mainly containing noise. An adaptive filtering technique can be used to eliminate the noise component in the signal mainly containing voice according to the relativity of the noise component contained in the signal mainly containing voice and the signal mainly containing noise. However, in some critical applications, such as in a mobile phone, the two microphones provided therein could hardly satisfy the above requirements, whereby the noise suppression effect may be greatly weakened. Thus, a pair of polar-type microphones is often used to ensure one microphone for recording a signal mainly containing voice, the other microphone for recording a signal mainly containing noise. However, the polar-type microphones are expensive.

Thus, there is a need for techniques for effectively enhancing the voice quality in communication devices.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques to enhance voice signals in a dual microphone system. According to one aspect of the present invention, there are at least two microphones that are positioned in a pre-configured array. Two audio signals x₁(k) and x₂(k) are received and coupled to an adjusting module. The adjusting module is provided to control the gain of each of the audio signals x₁(k) and x₂(k) to minimize signal differences between the two signals. A separation module is provided to receive the matched audio signals x′₁(k) and x′₂(k) from the adjusting module. The separation module separates the audio signals x′₁(k) and x′₂(k) to obtain a first audio signal s(k) mainly containing the voice and a second audio signal n(k) mainly containing the noise. An adaptive filtering module is provided to eliminate the noise component in the audio signal s(k) to obtain an estimated voice signal e_s(k) with a higher S/N ratio. Furthermore, the adaptive filtering module can be also configured to suppress echo in the audio signal s(k) at same time. The voice signal e_s(k) may be further coupled to a single-channel voice enhancement module that is configured to eliminate any residual of the noise component in the voice signal e_s(k) according to the differences between the voice signal and the noise signal in time domain and frequency domain, whereby, the S/N ratio is further enhanced.

One of the objects, features, and advantages of the present invention is to provide techniques for enhancing audio or voice signals in a dual-microphone system.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a functional block diagram of processing signals from a dual microphone system according to one embodiment of the present invention;

FIG. 2A is a functional block diagram showing how to train an adaptive filter into a compensation filter;

FIG. 2B shows an exemplary adjusting process that may be used in the functional block diagram of FIG. 2A;

FIG. 3 shows that two signals from two microphones MIC A and MIC B are coupled to an average energy comparator that calculates respective average energy of the two signals in a short time frame;

FIG. 4 shows a functional block diagram of determining an estimated audio signal and a noise signal from two processed signals from two microphones;

FIG. 5 shows modules configured to realize an MT/N fractional delay; and

FIG. 6 shows a linear latter filtering module that may be used in the functional block diagram of FIG. 1.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

According to one embodiment of the present invention, two non-directional microphones relatively adjacently posited in back-to-back type are provided for recording an audio signal. The two microphones may also be posited in side-by-side or other types. The audio signal recorded by either microphone contains speaker's voice and background noise. If a communication device equipped with the two microphones is in hands-free situation, the audio signal further contains the speaker's echo coming from the remote endpoint.

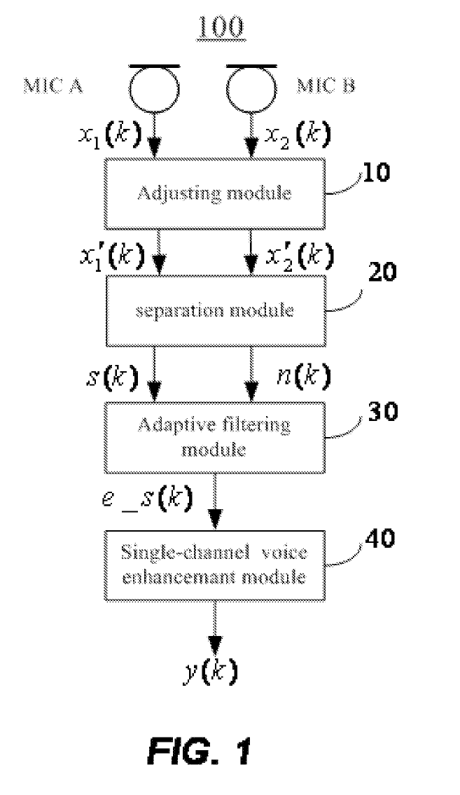

FIG. 1 is a functional block diagram 100 that may be advantageously used in a dual microphone system according to one embodiment of the present invention. The dual microphone system may be used in a communication device, such as a cell phone. The block diagram 100 comprises a pair of microphones A and B (indicating MIC A and MIC B), an adjusting module 10, a separation module 20, and an adaptive filtering module 30.

In operation, MICS A and B record two audio signals x₁(k) and x₂(k) that are provided to the adjusting module 10. The adjusting module 10 controls the gain of each of the audio signals x₁(k) and x₂(k) according to the difference between the signals. In order to make sure that even when the response characteristics of the MICS A and B do not completely match, the separation module 20 can still obtain the matched audio signals x′₁(k) and x′₂(k) from the adjusting module 10. The separation module 20 separates the audio signals x′₁(k) and x′₂(k) to obtain a first audio signal s(k) mainly containing the voice and a second audio signal n(k) mainly containing the noise. Generally, depending on location of the two microphones (i.e., an array), the noise source and the voice source come in different directions, and the voice source is typically closer to the microphone array.

In one embodiment, it is assumed that the voice source comes to the front of the microphone array, and the noise source comes from other directions (e.g., sides or back of the microphone array). The audio signal s(k) mainly containing the voice and the audio signal n(k) mainly containing the noise are coupled to the adaptive filtering module 30. The adaptive filtering module 30 eliminates the noise component in the audio signal s(k) according to the relationship of the noise component n(k) with the audio signals s(k) to obtain an estimated voice signal e_s(k) with a higher S/N ratio, the detail of which is further described below. Furthermore, the adaptive filtering module 30 can be also configured to suppress echo in the audio signal s(k) at same time. In one embodiment, the voice signal e_s(k) may be further coupled to a single-channel voice enhancement module 40. The single-channel voice enhancement module 40 further eliminates any residual of the noise component in the voice signal e_s(k) according to the differences between the voice signal and the noise signal in time domain and frequency domain, whereby, the S/N ratio is further enhanced.

The modules are now respectively described in detail below.

### The Adjust Module 10

Ideally, the separation module 20 requires that MIC A and MIC B have similar response characteristics of amplitude/frequency. However, in reality, the microphones which are highly matched and have reliable characteristics are expensive and not suitable to some popular commodity such as cell phone. In order to make sure that the separation module 20 can obtain highly matched signals, the adjust module 10 is provided to automatically adjust the characteristics differences between the pair of microphones. Depending on implementation, the adjust module 10 may be implemented by at least two ways.

### (1) Utilizing an Adaptive Filter

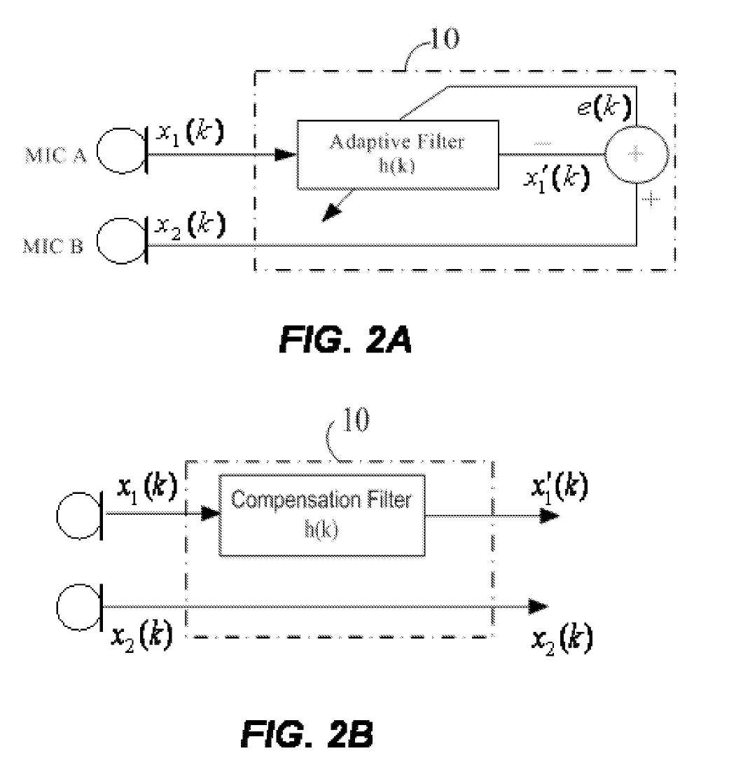

FIG. 2A is a functional block diagram showing how to train an adaptive filter into a compensation filter. Two input signals of the adaptive filter h(k) are x₁(k) from the MIC B and x₂(k) from the MIC A, respectively. If the energy of the adaptive filter output signal e(k) is lower than a preset threshold, a coefficient of the adaptive filter h(k) is set as a compensation filter coefficient.

An exemplary adjusting process is shown in FIG. 2B, the compensated signal x′₁(k) from the compensation filter is coupled to the signal separation module 20. In one embodiment, a coefficient updating algorithm used in the adaptive filter in FIG. 2A is the NLMS and BNLMS algorithm. In addition, those skilled in the art that the compensation filter coefficient could be automatically or manually adjusted or updated when needed.

### (2) Adaptive Gain Balance Method Based on Signal Energy

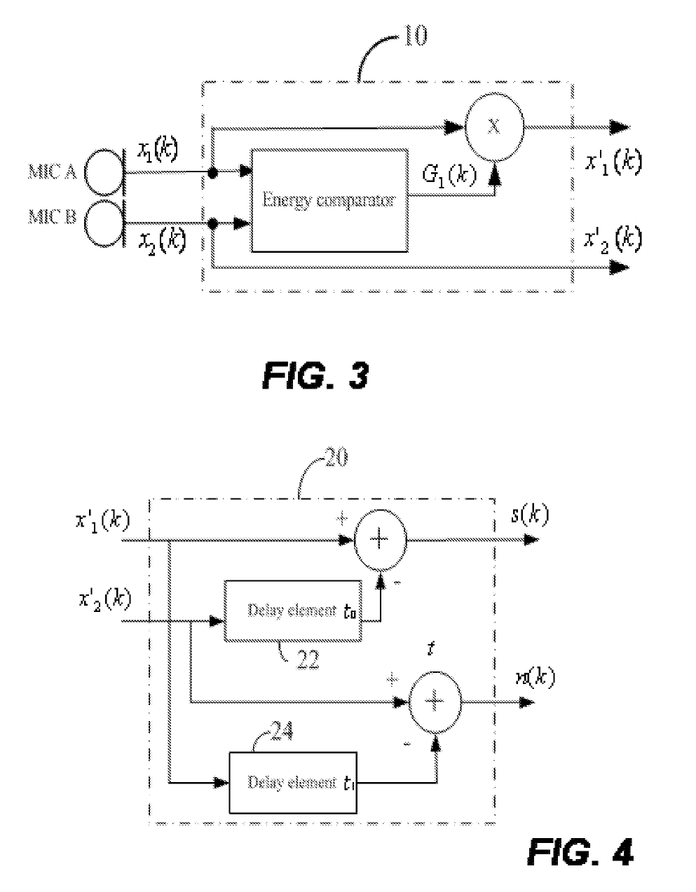

As it shown in FIG. 3, two signals x₁(k) and x₂(k) received by two microphones MIC A and MIC B are coupled to an average energy comparator. The average energy comparator calculates respective average energy of the two signals e₁(k) and e₂(k) in a short time frame, and according to the difference between the energies, a gain adjust factor G₁(k) can be obtained. The signal x′₁(k) is then multiplied by the gain adjust factor G₁(k) to get an adjust signal x′₁(k), the signals x′₁(k) and x₂(k) are then coupled to the signal separation module.

The average energy in a short time frame and the gain adjust factor could be determined according to the following equations:

$$\begin{matrix}{E}_{i} ( k ) = \frac{1}{L} {\sum }_{n = k - L + 1}^{k} {x}_{i}^{2} ( n ) ( i = 1 , 2 ) & \text{(1.1)} \\ {G}_{1} ( k ) = sqrt ( \frac{{E}_{2} ( k )}{{E}_{1} ( k )} ) & \text{(1.2)} \\ {x}_{1}^{′} ( k ) = {G}_{1} ( k ) {x}_{1} ( k ) & \text{(1.3)}\end{matrix}$$

where L stands for a block length when calculating the average energy.

The adaptive gain adjust could either act on one signal or on both of the two signals, the gain factor calculation may be performed as follows:

$$\begin{matrix}{E}_{sum} ( k ) = {E}_{1} ( k ) + {E}_{2} ( k ) & \text{(1.4)} \\ {G}_{1} ( k ) = sqrt ( \frac{{E}_{sum} ( k )}{2 {E}_{1} ( k )} ) & \text{(1.5)} \\ {G}_{2} ( k ) = sqrt ( \frac{{E}_{sum} ( k )}{2 {E}_{2} ( k )} ) & \text{(1.6)} \\ {x}_{1}^{′} ( k ) = {G}_{1} ( k ) {x}_{1} ( k ) & \text{(1.7)} \\ {x}_{2}^{′} ( k ) = {G}_{2} ( k ) {x}_{2} ( k ) & \text{(1.8)}\end{matrix}$$

### (b). The Separation Module 20

As shown in FIG. 4, the two input signals of this module are the adjusted voice signal with noise signal x′₁(k) and the signal x′₂(k). The signal separation module outputs s(k) and n(k), wherein s(k) contains mainly a valid voice signal from the front part of the microphone, n(k) contains mainly a noise signal from the back and sides.

In one embodiment, the signal separation module is implemented based on a beamforming technique that is an important part of the microphone array signal processing theory. It is a space filtering method by means of different positions of different signal sources to separate different signal types, which is detailed in B. Michael, W.Darren, Microphone Arrays—signal processing techniques and applications, Springer-Verlag publishing group, 2001, which is hereby incorporated by reference.

One of the features in the present invention is to take two back-to-back non-directional microphones to realize one order differential microphone array technique as an example to explain the signal separation module. As shown in FIG. 4, x′₁(k) is an adjusted signal gathered from the front microphone, x′₂(k) is the adjusted signal gathered from the hidden microphone. The following description is focused on one order differential microphone array technique. It is supposed that the microphones are nearly matched or they have been matched by a microphone adjustment process. Thus the signal x′₁(k) minus the delayed signal x′₂(k−t₀) leads to a signal n(k):

s(k)=x₁(k)−x′₂(k−t₀) (2.1)

n(k)=x₂(k)−x′₁(k−t₁) (2.2)

If it is assumed that the distance of the two microphones is d and the voice speed is c. The maximum time lag, when a voice reaches the two microphones (from the front input or from the back input), is

$$τ = \frac{d}{c} \qquad \text{(2.3)}$$

If t₀ and t₁ are set as a value between 0˜τ, it could simulate different microphone directional, which is detailed in Brian Csermak, A Primer on a Dual Microphone Directional System, The Hearing Review, January 2000, Vol. 7, No. 1, which is hereby incorporated by reference. If t₀ and t₁ are both valued at τ, it forms two back-to-back cardioid directional microphones. That is s(k) is the signal mainly from the front microphone, n(k) is the signal mainly from the back microphone. The following description is based on this assumption. However, t₀ and t₁ could be any other values so as to form different directivities such as hyper-cardioid.

As described above, some communication device, such as a cell phone, requires the distance between the two microphones being very small, so as to facilitate the miniaturization requirement. When d is quite small, d/c could be smaller than a sampling cycle, a fractional delay might happen. When the sampling cycle is 8 k, the voice transport distance in one sample point sampling time is:

$${d}^{′} = cT = 340 m / s \cdot \frac{1}{8000} s = 42.5 mm \qquad ( 3 )$$

Therefore, when d is about 1 cm, if the signal sampling frequency is a widely used communication sample frequency, such as 8 k or 16 k, the signal delay d/c means that it requires to delay a fractional sample point. Fractional delay is described in V. Valimaki and T. I. Laakso, Principles of fractional delay filters, l ICASSP 2000, which is also hereby incorporated by reference.

According to one embodiment, the present invention utilizes a multi sampling ratio signal process technique that is detailed in P. P. Vaidyanathan, Multirate systems and filter banks, Prentic Hall, which is hereby incorporated by reference, to realize a fractional delay. It is different from the common interpolation filtering method, when the signal sampling frequency is low. In one embodiment, the fractional delay is used with minimized calculation. The following description shows the implementation using the detailed fractional delay method.

It is assumed that the signal sampling frequency is set as f₀ H_{Z}, and the sampling cycle is:

$$T = \frac{1}{{f}_{0}} ( s ) \qquad \text{(4.1)}$$

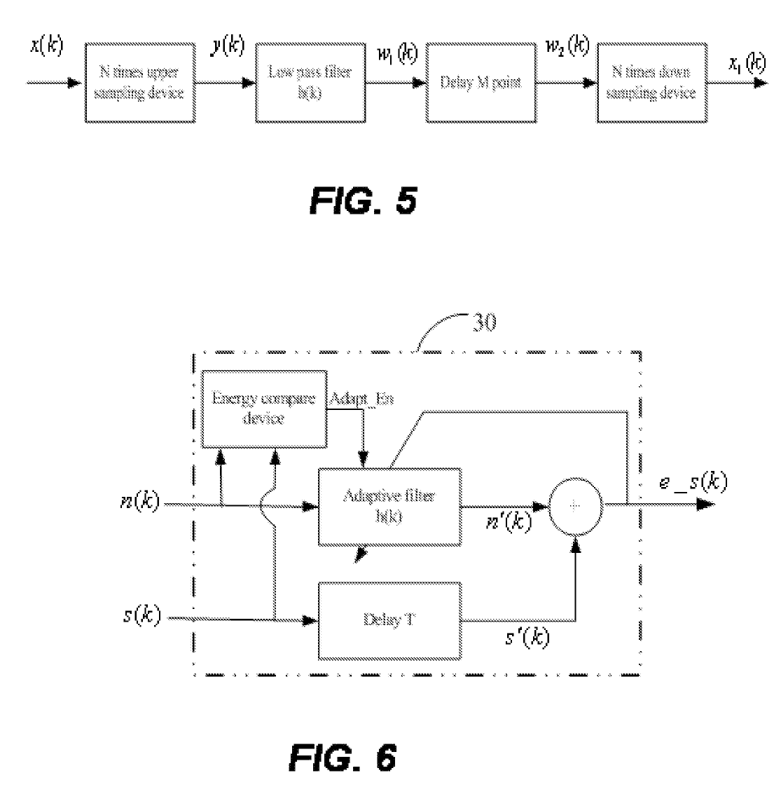

FIG. 5 shows a functional block diagram to realize an MT/N fractional delay, where M and N are nature numbers, and M<N. By adding N−1 zeros between any two points in N times upper sampling the signal x(k), and getting N times upper sampling the signal y(k), a low pass filter H₂(k) filters a mirror frequency component introduced from the upper sampling, and limits the signal bandwidth in f₀/2. The delayer delays the low pass filter output signal w₁(k) by M points and gets the signal w₂(k); Repeating N times abstraction to w₂(k) through N times down sampling device gets the output signal x₁(k). If the low pass filter H₂(k) is ideal, it gets:

$${x}_{1} ( k ) = x ( k - \frac{M}{N} ) \qquad \text{(4.2)}$$

The signal x₁(k) is the signal x(k) delayed M/N point. By means of the delay element in FIG. 4, it could get x′₁(k−t₁) after the delayed fractional delay t₁ from x′₁(k) and get x′₂(k−t₀) after the delayed fractional delay t₀. Then through the signal separation module in FIG. 4, s(k) and n(k) are obtained.

### (c). Linear after Filtering Module 30

In FIG. 4, the signal separation module output s(k) is mainly from the front voice signal, and it also includes a noise signal from back and sides, whose amplitude got attenuated. Another output n(k) also includes a voice signal.

The linear latter filtering module further eliminates a noise signal in the signal s(k) by means of the independency of the noise signal in s(k) and n(k). The echo signal gathered by the two microphones also has independency, so the module could eliminate echo too.

In a traditional technique, the latter filtering module utilizes one order adaptive filtering, not to eliminate noise but to realize different equivalent delay to get adaptive directional microphone effect, the detail of which is in Luo, J. Yang, C. Pavlovic and A. Nehorai, Adaptive null-forming scheme in digital hearing aids, IEEE Trans. on Signal Processing, Vol. SP-50, pp. 1583-1590, July 2002, which is hereby incorporated by reference.

FIG. 6 shows a schematic of a linear latter filtering module, as a counterpart to a single channel non-linear voice enhancement module. The output of the signal separation module s(k) and n(k) is coupled to an energy comparing device. The energy comparing device compares s(k) and n(k) energy value and generates an adaptive filter H₃(k) enable control signal Adapt_en. The control signal Adapt_en is used to control whether the adaptive filter needs to update its coefficient. The two input signals of the adaptive filter are n(k) and the delayed s(k) signal s′(k). The signal Adapt_en is used to assure that the adaptive filter coefficient adjust is not aimed at the voice but noise, which means it is only when the microphone gathered signal is mainly about noise renovate the adaptive filter coefficient. A simple way to generate control signal Adapt_en is utilizing one order recursion system to get x′₁(k) and x′₂(k) energy envelop ratio:

$$\begin{matrix}X1\_env ( k ) = α \cdot X1\_env ( k - 1 ) + ( 1 - α ) \cdot {x}_{1}^{2} ( k ) & \text{(5.1)} \\ X2\_env ( k ) = α \cdot X2\_env ( k - 1 ) + ( 1 - α ) \cdot {x}_{2}^{2} ( k ) & \text{(5.2)} \\ ratio ( k ) = \frac{X1\_env ( k )}{X2\_env ( k )} & \text{(5.3)}\end{matrix}$$

where X1_env(k) and X2_env(k) counterpart to k time point energy envelop of signal x₁(k) and signal x₂(k), a is smoothing operator which is less than 1.

Adapt_en compares with ratio(k) and threshold R0 and gets:

$$\{ \begin{matrix}ratio ( k ) < R0 & coefficient\_renovate \_start \\ ratio ( k ) \geq R0 & coefficient\_renovate \_stop\end{matrix} \qquad \text{(5.4)}$$

### For signal s(k) is mainly about front target voice signal and signal n(k) is mainly about back noise signal, above method could assure the adaptive filter aim at noise renovation.

In FIG. 6, the delay signal s(k) T time period is to assure the adaptive filter causality. In order to accurately control the delay T, to assure the adaptive filter causality and not induce unnecessary delay, the adaptive filter of the present invention utilizes L (L>1) order linear phase adaptive filter and the correspond T is L/2 point. Further the detail of the adaptive filter may be found in C. F. N. Cowan and P. M. Grant, Adaptive filters, Prentice Hall, 1985, which is hereby incorporated by reference.

In FIG. 6, the adaptive filter output is one-channel that is mainly target voice signal e_s(k). The signal e_s(k) is coupled to a non-linear voice enhancement module from which a final output is obtained. However a two-channel voice enhancement module needs two input signals, the detail of which may be found in I. Cohen, Two-channel signal detection and speech enhancement based on the transient beam-to-reference ratio, ICASSP 2003, which is hereby incorporated by reference. In the two outputs, the signal e_s(k) mainly includes a target voice signal, and the signal e_n(k) mainly includes a noise signal. Herein the structure of the two adaptive filters in the two-channel is substantially similar, exchanging the input signal and the reference signal, the control signals are contrary to each other, which means only one adaptive filter updates the coefficient at a time.

The linear latter filtering module of the present invention could remarkably raise the S/N ratio of the output signal. By utilizing the controlled multi-order adaptive filter, it is unlikely that the voice signal is filtered by mistake.

### (d). Non-Linear Voice Enhancement Module 40

The non-linear voice enhancement module enhances the voice signal by means of time-domain differences between the voice signal and the noise signal, the detail of which may be referred to in I. Cohen and B. Berdugo, Speech enhancement for non-stationary noise environments, signal processing, vol. 81, No. 11, pp 2403-2418, 2001, which is hereby incorporated by reference.

Generally, a non-linear voice enhancement module includes a voice presentation frequency judgment module for judging the probability of noise in the voice signal with noise. In one embodiment, the non-linear voice enhancement module includes a one-channel linear voice enhancement module and a two-channel voice enhancement module. The one-channel voice enhancement module is implemented based on the one-channel non-linear voice enhancement algorithm, according to one output signal e_s(k) for the voice probability judgment. The two-channel voice enhancement module is implemented based on a two-channel non-linear voice enhancement algorithm, according to two input signals, one including mainly a target voice signal, the other including mainly a noise signal. For this module to operate after the linear latter filtering module, it requires that the linear latter filtering module utilizes the two-channel mode.

When the non-linear voice enhancement module utilizes the one-channel non-linear voice enhancement module, the inner signal S/N ratio is low or the noise signal is a non-steady signal and its energy is close to that of the voice signal, the voice presentation frequency judgment module could hardly make a correct judgment, therefore it reduces the fidelity of the voice signal while reducing the noise amplitude. However, when utilizing the two-channel non-linear voice enhancement module, one channel is mainly about the target voice signal and the other channel is mainly about the noise signal, it could judge the voice presentation frequency more correctly. Therefore, it could suppress the defect of the one-channel non-linear voice module but the system could be more complex.

By using the present invention of the dual microphone voice enhancement system, it could eliminate possible background voice and background music which a one-channel voice enhancement module could hardly achieve. Under the condition that the S/N ratio is very low, it still could get the good noise elimination effect. The two adjacent common non-directional microphones could save money which serves the purpose of the mobile device miniaturization. Each signal processing module in the FIG. 2A could be figured to reach the best behavior price ratio based on the quality and power consumption requirement. It could also add a residual echo suppression module and an automatic gain control module when needed, as it shown in FIG. 2B. For non-linear distort in a voice output device, such as speaker, the linear latter filtering module could not eliminate echo completely. The residual echo suppression module is used to suppress the residual echo in the output of the latter filtering module. It usually requires a short time energy envelop to estimate a residual echo energy floor, if the present signal short time energy envelop is under the energy floor, dilute the present signal, otherwise make no change in this module. In order to further enhance the quality of the output voice, the output of the non-linear voice enhancement module z(k) is coupled to the automatic gain control module when being coupled to the output amplifier. The automatic gain module analyzes the signal z(k) to output control information, adjust gain in the output amplifier automatically based on the amplitude of the signal z(k) to assure that even when the signal z(k) alternates in amplitude, the output power of the signal z′(k) remains substantially similar.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. A method for voice enhancement, the method comprising:
obtaining two audio signals from two microphones;
adjusting the two audio signals so that characteristics of the two audio signals are substantially similar;
producing from the two audio signals a first audio signal mainly containing a voice signal and a second audio signal mainly containing a noise signal according to differences between a voice source and a noise source in a space domain;
eliminating the noise signal mixed in the first audio signal to produce a voice signal with a S/N ratio; and
enhancing the voice signal in a single-channel voice enhancement module so that the S/N ratio in the voice signal is further enhanced.

2. The method as claimed in claim 1, wherein the two microphones are in a communication device, one of the two microphones is primarily for receiving the voice signal and the other one of the two microphones is primarily for receiving the noise signal.

3. The method as claimed in claim 1, wherein said adjusting the two audio signals comprises adjusting respective gains of the two audio signals.

4. The method as claimed in claim 1, further comprising eliminating the noise signal in the voice signal according to differences between the voice signal and the noise signal in either one or both of a time domain and a frequency domain.

5. The method as claimed in claim 1, wherein the two audio signals are labeled, respectively, as x₁(k) and x₂(k), and the two corresponding adjusted audio signals are labeled respectively, as x′₁(k) and x′₂(k), said producing from the two audio signals a first audio signal and a second audio signal is performed in accordance with equations as follows:
$$s ( k ) = {x}_{1}^{′} ( k ) - {x}_{2}^{′} ( k - {t}_{0} )$$
$$n ( k ) = {x}_{2}^{′} ( k ) - {x}_{1}^{′} ( k - {t}_{1} )$$
$$τ = \frac{d}{c} .$$
wherein s(k) is the first audio signal and n(k) is the second audio signal;
d represents a distance between the pair of microphones;
c represents a voice speed.

6. The method as claimed in claim 5, further comprising:
adding N−1 zeros between any two points in N times upper sampling the signal x(k); and
getting N times upper sampling the signal x′(k).

7. The method as claimed in claim 6, further comprising:
using a low pass filter H₂(k) to filter a mirror frequency component brought in from said upper sampling,
limiting a signal bandwidth to f₀/2; and
outputting a signal w₁(k).

8. The method as claimed in claim 7, still further comprising:
delaying the signal w₁(k) by M points to obtain a signal w₂(k);
doing N times abstraction to w₂(k) through an N times down sampling device;
getting a first output signal;
getting a second output signal in the same way as getting the first output; and
comparing and balancing respective energies of both first and second signals.

9. The method as claimed in claim 5, further comprising:
comparing respective energy values of the signal s(k) and the signal n(k) to generate an adaptive filter H₃(k) enable control signal Adapt_en, wherein the control signal Adapt_en is used to control whether an adaptive filter coefficient shall be updated;
delaying the signal s(k) to get a delayed signal s′(k);
adaptively filtering the signal n(k) to get a signal n′(k); and
adding the signal s′(k) and the signal n′(k) to get an estimated signal e_s(k).

10. The method as claimed in claim 9, wherein the signal Adapt_en is used to assure that the adaptive filter coefficient adjusted is not aimed at the voice signal but the noise signal.

11. A device for voice enhancement, the device comprising:
a separation module for separating two input audio signals x′₁(k) and x₂′(k) to produce a first audio signal s(k) mainly containing voice and a second audio signal n(k) mainly containing noise according to differences between a voice source and a noise source in an air domain; and
an adaptive filtering module for eliminating the noise mixed in the first audio signal s(k) according to relativity of the noise contained in the first audio signal s(k), to produce a voice signal e_s(k).

12. The device as claimed in claim 11, further comprising:
an adjusting module for adjusting a gain value of either one or both of the two audio signals according to differences between the two audio signal; and
a voice enhancement module for eliminating the noise in the voice signal e_s(k) according to differences between voice signal and noise signal in time domain and frequency domain.
